(19) United States
(12) Patent Application Publication
(10) Pub. No.: US 2007/0192599 A1
(43) Pub. Date: Aug. 16, 2007

(54) Authentication method and authentication system

(75) Inventors: Junji Kato, Tokyo (JP); Hirokazu Tsuruta, Hyogo (JP)

Correspondence Address: MCDERMOTT WILL & EMERY LLP, 600 13TH STREET, N.W., WASHINGTON, DC, 20005-3096, US

(73) Assignee: RENESAS TECHNOLOGY CORP.

(21) Appl. No.: 11/338,669

(22) Filed: Jan. 25, 2006

(30) Foreign Application Priority Data
Jan. 28, 2005 (JP) JP2005-021295

(51) Int. Cl. H04L 9/00

(52) U.S. Cl. 713/168

(57) ABSTRACT

After a selection key bundle is determined by a selection key bundle determining process, the following first authentication key authenticating process is executed. An authentication processing part selects a selection encryption key from selection key bundle following a predetermined association based on a received random-number data. On the other hand, another authentication processing part selects an encryption key from the selection key bundle as a selection encryption key, following the association based on the received random-number data, encrypts the random-number data using the selection encryption key so as to acquire encrypted random-number data and transmits to the former authentication processing part. The former authentication processing part decrypts the encrypted random-number data using the selection encryption key so as to acquire decrypted random-number data and then determines whether that authentication is acceptable based on a comparison between the transmission time original random-number data and decrypted random-number data.

### BACKGROUND OF THE INVENTION

1. Field of the Invention

The present invention relates to an authentication device having an authentication function relating to data transmission and reception.

2. Description of the Background Art

As a communication system in which the intensity of communication security upon communication through a network is secured, for example, a communication system disclosed in Japanese Patent Application Laid-Open No. 2004-356783 is available. This communication system generates a secret target key by exchanging key information in order to communicate with other person and, upon the exchanging process, a plurality of pieces of key information are transmitted/received.

Further, to certify validity of encryption key used by both a transmitter and a receiver, a communication system has an authentication device having an authentication function relating to exchange of data. Generally, the authentication device stores data such as key/management number in a nonvolatile memory, and authenticates mutually whether or not both the transmitter and the receiver satisfy a requirement for ability to exchange data by encrypting/decrypting according to common key encrypting system before data transmission and reception. As data processing system which has disclosed mutual authentication using the common key, a system disclosed in Japanese Patent Application Laid-Open No. 2000-332748 has been well known.

According to the authentication using the common key encryption method, both the transmitter and the receiver need to use a same encryption key (encryption key used for authentication). If the common key encryption method is used, generally, both of them possess one kind of the encryption key according to a conventional technology. In this case, there is such a problem that the encryption key is specified easily by an offensive person who tries to specify the encryption key.

In order to solve the aforementioned problem, it is considered that both the transmitter and the receiver use a plurality of encryption keys. In this case, one of the transmitter and the receiver must send, to the other one of them, encryption key selection information indicating a type of an encryption key selected from the plurality of encryption keys. Therefore, there is a risk that the encryption key selection information is specified by an offensive person at the time of sending the information.

Further, in the case where an authenticating process for authenticating commonality of encryption keys possessed by the transmitter and receiver without sending the encryption key selection information, an encryption key selected from the plurality of encryption keys and used for authentication is not specified; therefore, there arises a necessity that one of the transmitter and receiver must extract an encryption key corresponding to the encryption key selected from the plurality of encryption keys and specified by the other one of them. In the worst case, there arises a necessity that an authenticating process must be executed using all of the plurality of encryption keys. As a result, there is a problem that the authenticating process becomes complicated and is not practical.

### SUMMARY OF THE INVENTION

An object of the present invention is to provide an authentication method having an authentication function of authenticating commonality of encryption keys and ensuring a high security performance against an offensive person without complicating an authenticating process.

According to a first aspect of the present invention, there is provided an authentication method for authenticating commonality of encryption keys possessed by first and second authentication devices. Herein, each of the first and second authentication devices includes an authentication processing part which executes an authenticating process, and a transmission/reception part which transmits/receives data at the time of the authenticating process,

The authentication processing part includes an authenticating process control part, a storage part, an encryption/decryption circuit and a random-number generation circuit.

The authenticating process control part executes and controls the authenticating process. The storage part stores a key bundle having a plurality of encryption keys. Each of the key bundles contains a predetermined number of key bundles each having a plurality of encryption keys. The encryption/decryption circuit encrypts/decrypts data using a selection encryption key. The random-number generation circuit generates random-number data.

The authenticating process is executed in such a state that data transmission and reception via each transmission/reception part is enabled with the first authentication device as one side and the second authentication device as the other side, and includes the following steps (a) to (e).

The step (a) is to recognize a selection key bundle which is one key bundle contained in the predetermined number of key bundles by data transmission and reception between the one side and the other side. The step (b) is to transmit initial communication random-number data based on original random-number data which is random-number data generated from the authentication processing part from the one side to the other side. The one side executes a predetermined association based on the original random-number data to select one encryption key from the plurality of encryption keys in the selection key bundle as a selection encryption key for the one side. The step (c) is to receive the initial communication random-number data on the other side, acquire the original random-number data from the initial communication random-number data using an initial random-number recognition method, execute the predetermined association based on the original random-number data to select one encryption key from the plurality of encryption keys in the selection key bundle as a selection encryption key for the other side, acquire encrypted random-number data by encrypting the original random-number data using the selection encryption key for the other side, and transmit the encrypted random-number data to the one side. The step (d) is to receive the encrypted random-number data on the one side, and to acquire decrypted random-number data by decrypting the encrypted random-number data using the selection encryption key for the one side. The step (e) is to compare the original random-number data with the decrypted random-number data on the one side and determine whether or not an authentication result is acceptable depending on whether the comparison result is consistent or inconsistent.

In the authentication method according to the first aspect of the present invention, since the selection encryption key is changed at each authenticating process by selecting the selection encryption key from a plurality of encryption keys based on the random-number data, a risk that a selection encryption key may be read upon execution of an authenticating process is reduced largely, so that security against an attack by a third party may be raised. Additionally, since the processes of the steps (b) to (e) may be automatically executed under a control of the authenticating process control part, an authenticating process is never complicated.

Furthermore, since a key bundle is set as a selection key bundle from the predetermined number of key bundles in the step (a), the security against an attack by a third party upon execution of an authenticating process may be raised.

According to a second aspect of the present invention, there is provided an authentication method for authenticating commonality of encryption keys possessed by first and second authentication devices. Herein, each of the first and second authentication devices includes an authentication processing part which executes an authenticating process, a transmission/reception part which transmits/receives data at the time of the authenticating process, and a clock function.

The authentication processing part includes an authenticating process control part, a storage part, an encryption/decryption circuit and a random-number generation circuit.

The authenticating process control part executes and controls the authenticating process. The storage part stores a key bundle having a plurality of encryption keys. The encryption/decryption circuit encrypts/decrypts data using a selection encryption key. The random-number generation circuit generates random-number data.

The authenticating process is executed in such a state that data transmission and reception via each transmission/reception part is enabled with the first authentication device as one side and the second authentication device as the other side, and includes the following steps (b) to (e).

The step (b) is to transmit initial communication random-number data based on original random-number data which is random-number data generated from the authentication processing part from the one side to the other side. The one side executes a predetermined association based on an authentication time for the one side at a predetermined timing in the authenticating process to select one encryption key from the plurality of encryption keys in the key bundle as a selection encryption key for the one side. The step (c) is to receive the initial communication random-number data on the other side, acquire the original random-number data from the initial communication random-number data using an initial random-number recognition method, execute the predetermined association based on an authentication time for the other side capable of being identified with the authentication time for the one side to select one encryption key from the plurality of encryption keys in the key bundle as a selection encryption key for the other side, acquire encrypted random-number data by encrypting the original random-number data using the selection encryption key for the other side, and transmit the encrypted random-number data to the one side. The step (d) is to receive the encrypted random-number data on the one side, and to acquire decrypted random-number data by decrypting the encrypted random-number data using the selection encryption key for the one side. The step (e) is to compare the original random-number data with the decrypted random-number data on the one side and determine whether or not an authentication result is acceptable depending on whether the comparison result is consistent or inconsistent.

In the authentication method according to the second aspect of the present invention, since the selection encryption key is changed for each authenticating process by selecting the selection encryption key for the one side and the other side from a plurality of encryption keys based on the authentication times for the one side and the other side capable of being identified with each other, a risk that the selection encryption key may be read at the time of execution of an authenticating processing is reduced largely, so that a high security against an attack by a third party can be ensured. Additionally, since the processes of the steps (b) to (e) may be automatically executed under a control of the authenticating process control part, an authenticating process is never complicated.

According to a third aspect of the present invention, there is provided an authentication method for authenticating commonality of encryption keys possessed by first and second authentication devices. Herein, each of the first and second authentication devices includes an authentication processing part which executes an authenticating process, a transmission/reception part which transmits/receives data at the time of the authenticating process, and a temperature sensor which can measure a temperature of a device as a detection temperature.

The authentication processing part includes an authenticating process control part, a storage part, an encryption/decryption circuit and a random-number generation circuit.

The authenticating process control part executes and controls the authenticating process. The storage part stores a key bundle having a plurality of encryption keys. The encryption/decryption circuit encrypts/decrypts data using a selection encryption key. The random-number generation circuit generates random-number data.

The authenticating process is executed in such a state that data transmission and reception via each transmission/reception part is enabled with the first authentication device as one side and the second authentication device as the other side, and includes the following steps of (b) to (e).

The step (b) is to transmit initial communication random-number data based on original random-number data which is random-number data generated from the authentication processing part from the one side to the other side. The one side executes a predetermined association based on a detection temperature on the one side detected by the temperature sensor at a predetermined timing during the authenticating process to select one encryption key from the plurality of encryption keys in the selection key bundle as a selection encryption key for the one side. The step (c) is to receive the initial communication random-number data on the other side, acquire the original random-number data from the initial communication random-number data using an initial random-number recognition method, execute the predetermined association based on a detection temperature on the other side capable of being identified with the detection temperature on the one side to select one encryption key from the plurality of encryption keys in the selection key bundle as a selection encryption key for the other side, acquire encrypted random-number data by encrypting the original random-number data using the selection encryption key for the other side, and transmit the encrypted random-number data to the one side. The step (d) is to receive the encrypted random-number data on the one side, and to acquire decrypted random-number data by decrypting the encrypted random-number data using the selection encryption key for the one side. The step (e) is to compare the original random-number data with the decrypted random-number data on the one side and determine whether or not an authentication result is acceptable depending on whether the comparison result is consistent or inconsistent.

In the authentication method according to the third aspect of the present invention, since the selection encryption key is changed for each authenticating process by selecting selection encryption keys for the one side and the other side from a plurality of encryption keys based on the detection temperatures on the one side and the other side capable of being identified with each other, a risk that a selection encryption key may be read at the time of execution of an authenticating process is reduced largely, so that a high security against an attack by a third party may be ensured. Additionally, since the processes of the steps (b) to (e) may be automatically executed under a control of the authenticating process control part, an authenticating process is never complicated.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the structure of an authentication device for use in an authentication method according to a first embodiment of the present invention;

FIG. 2 is a block diagram showing the internal structure of an authentication processing part shown in FIG. 1;

FIG. 3 is an explanatory diagram showing a key bundle group stored in a nonvolatile memory shown in FIG. 2;

FIG. 4 is an explanatory diagram showing the content of authenticating process between two authentication devices:

FIG. 5 is a block diagram showing the structure of the authentication device for use in the authentication method of the second embodiment;

FIG. 6 is a block diagram showing the structure of the authentication device for use in the authentication method of the third embodiment;

FIG. 7 is a block diagram showing part of the structure of an electric bicycle according to a fourth embodiment of the present invention;

FIG. 8 is an explanatory diagram showing the internal structure of the key for the electric bicycle key shown in FIG. 7 and battery;

FIG. 9 is a flowchart showing the content of authentication controlling process between electric bicycle key and battery of the electric bicycle according to the fourth embodiment;

FIG. 10 is a block diagram showing part of the structure of communication karaoke system according to a fifth embodiment of the present invention;

FIG. 11 is an explanatory diagram showing the internal structure of a terminal and server shown in FIG. 10;

FIG. 12 is a flowchart showing the content of authenticating process between the terminal and server of the communication karaoke system of the fifth embodiment;

FIG. 13 is a block diagram showing part of the structure of shop control system according to a sixth embodiment of the present invention;

FIG. 14 is an explanatory diagram showing the internal structure of a door key and door key hole shown in FIG. 13;

FIG. 15 is a flowchart showing the content of authentication controlling process between a door key hole 62 and a door key 61 of the shop control system of the sixth embodiment; and

FIG. 16 is an explanatory diagram showing other embodiment of the key bundle group stored within the nonvolatile memory shown in FIG. 2.

### DESCRIPTION OF THE PREFERRED EMBODIMENTS

### First Embodiment

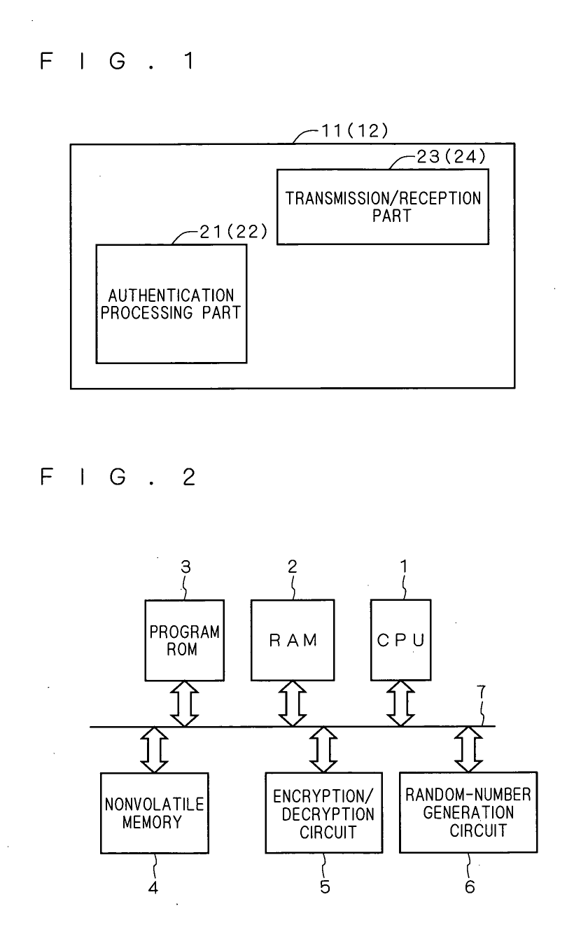

FIG. 1 is a block diagram showing the structure of an authentication device for use in the authentication method according to the first embodiment of the present invention. As indicated in FIG. 1, an authentication device 11 includes an authentication processing part 21 and a transmission/reception part 23 internally as indispensable constituent elements. The transmission/reception part 23 exchanges data with the transmission/reception part 24 of other authentication device 12. In the meantime, an authentication device 12, which receives data from the authentication device 11, also includes an authentication processing part 22 and a transmission/reception part 24 like the authentication device 11.

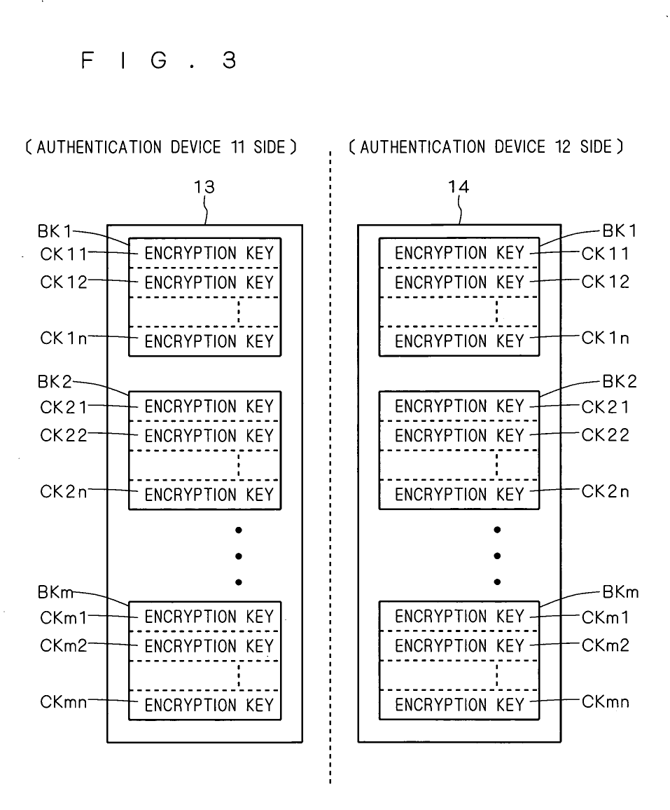

FIG. 2 is a block diagram showing the internal structure of the authentication processing part 21 (22). As indicated in FIG. 2, the authentication processing part 21 (22) includes a CPU 1, a RAM 2, a program ROM 3, a nonvolatile memory 4, an encryption/decryption circuit 5 and a random-number generation circuit 6 internally. The respective constituent elements 1 to 6 are capable of exchanging data with each other via a shared bus 7. Meanwhile, the authentication processing part 22 has the same structure as the authentication processing part 21.

The CPU 1 executes authentication program or the like memorized in the program ROM 3. The RAM 2 stores temporary information for use when the CPU executes the authentication program. The program ROM 3 stores authentication program. The nonvolatile memory 4 functions as a memory unit which stores the key bundle group, identification information and the like, which will be described later.

The encryption/decryption circuit 5 executes an encrypting/decrypting process based on a selection encrypting key. The random-number generation circuit 6 generates a random number for use in an authenticating process.

FIG. 3 is an explanatory diagram showing the key bundle groups 13, 14 stored within the nonvolatile memory 4 of each of the authentication devices 11, 12. As indicated in FIG. 3, a key bundle group 13 is stored in the nonvolatile memory 4 on the side of the authentication device 11 and the key bundle group 13 has m (≧2) encryption key BK1 to BKm and each key bundle BKi (I=1−m) has n (≧2) encryption keys Cki1 to CKin.

On the other hand, the authentication processing part 22 of the other authentication device 12 which exchanges data with the authentication device 11 also has a key bundle group 14 having the same structure.

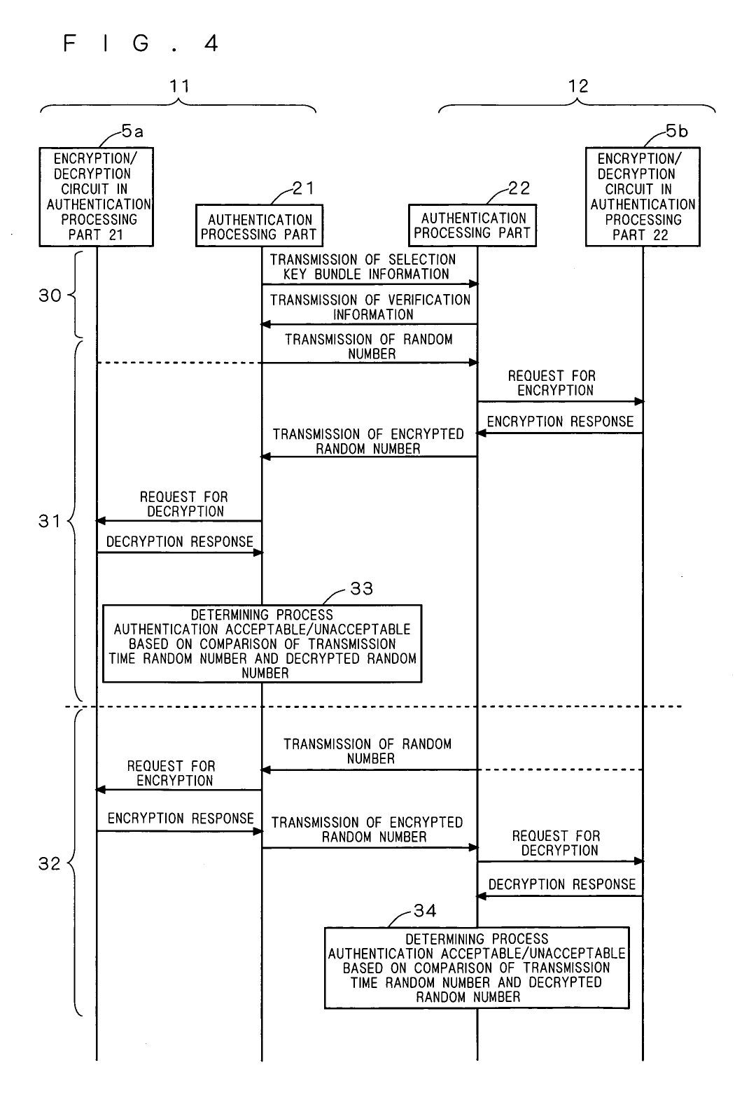

FIG. 4 is an explanatory diagram showing an authenticating process between the authentication devices 11 and 12. This authenticating process is an independent process of data communication to be executed as a preprocess of data communication between the authentication devices 11 and 12. According to the first embodiment, the authenticating process is constituted of a selection key bundle determining process 30, a first encryption key authenticating process 31 and a second encryption key authenticating process 32, and these processes are executed based on an authentication program stored in the program ROM 3 under a control by the CPU 1. Therefore, the CPU 1, RAM 2 and program ROM 3 functions as authenticating process control part.

Although data transmission and reception between the authentication devices 11 and 12 is carried out actually through the transmission/reception part 23 of the authentication device 11 and the transmission/reception part 24 of the authentication device 12, it will be described as a data exchanging process between the authentication processing parts 21 and 22. To clarify a difference between the respective constituent elements 1 to 5 of the authentication processing parts 21 and 22, the respective constituent elements 1 to 5 in the authentication processing part 21 are marked as 1a to 5a and the respective constituent elements 1 to 5 in the authentication processing part 22 are marked as 1b to 5b.

First, the selection key bundle determining process 30 is carried out between the authentication devices 11 and 12. Of the key bundles BK1 to BKm in the key bundle group 13, the authentication processing part 21 determines a selection key bundle SBK for use in the authenticating process of this time prior to the first authentication key authenticating process 31 and the second authentication key authenticating process 32 and after the selection key bundle information indicating the selection key bundle SBK is stored in the nonvolatile memory 4a, transmits selection key bundle information indicating the selection key bundle SBK to the authentication processing part 22.

The authentication processing part 22, after receiving the selection key bundle information, fetches the selection key bundle information indicating the selection key bundle SBK into the nonvolatile memory 4b and transmits certification information indicating that the selection key bundle SBK is received.

As a result of the abovementioned process, the selection key bundle determining process 30 which determines the selection key bundle SBK for use in the authenticating process between the authentication devices 11 and 12 is ended.

After the selection key bundle determining process 30 is ended, the first encryption key authenticating process 31 is executed. The authentication processing part 21 transmits random-number data (data composed of at least a random number) generated from the random-number generation circuit 6a to the authentication processing part 22 without encrypting. At this time, the authentication processing part 21 selects an encryption key as the selection encryption key SCKa from the encryption keys Cki1 to CKin in the selection key bundle SBK in accordance with the association determined preliminarily based on the received random data and stores the selection authenticating key information indicating the selection authenticating key SCKa within the nonvolatile memory 4a.

After receiving the random data, the authentication processing part 22 selects an encryption key as the selection encryption key SCKb from the encryption keys Cki1 to CKin within the selection key bundle SBK following the abovementioned interrelation (the same relation as used by the authentication processing part 21) based on the received random data, stores the selection authenticating key SCKb in the information nonvolatile memory 4b and requests the encryption/decryption circuit 5b to encrypt it.

As for the above-mentioned interrelation based on the random data, for example, if eight pieces of the encryption keys Cki1 to CKin exist (n=8), a method in which first random numbers or the like in the random-number data are converted to 3 bits as they are or according to a predetermined equation and any of the encryption keys Cki1 to CKi8 is interrelated based on such 3-bit values can be considered.

When receiving an encryption request, the encryption/decryption circuit 5b executes encrypting response for generating encrypted random-number data by encrypting random-number data received using the selection encryption key SCKb. Then, the authentication processing part 22 transmits encrypted random-number data to the authentication processing part 21.

After receiving encrypted random-number data, the authentication processing 21 requests the encryption/decryption circuit 5a to decrypt the encrypted random-number data.

After receiving the decryption request, the encryption/decryption circuit 5a executes decrypting response of generating the decrypted random-number data by decrypting the encrypted random-number data using the selection encryption key SCKa.

The authentication processing part 21 executes a determining process 33 based on comparison of original random-number data and decrypted random which is random-number data at the time of transmission number data. Hereinafter, the determining process 33 will be described.

If the original random-number data and the decrypted random-number data coincide, the authentication processing part 21 determines that the selection encryption key SCKa of the authentication processing part 21 and the selection encryption key SCKb of the authentication processing part 22 coincide and determines that the authentication is acceptable as a result of authentication. On the other hand, unless the original random-number data and decrypted random-number data coincide, the authentication processing part 21 determines that the selection encryption key SCKa of the authentication processing part 21 and the selection encryption key SCKb of the authentication processing part 22 do not coincide and determines that the authentication is unacceptable as a result of the authentication.

After the abovementioned process, the first encryption key authenticating process 31 is ended. The first authentication key authenticating process 31 is an authenticating process from one side to the other side, in which the authentication device 11 is set as one side while the authentication device 12 is set as the other side.

When the first encryption key authenticating process 31 is ended, the procedure proceeds to the second encryption key authenticating process. The second authentication key authenticating process is an authenticating process from one side to the other side, in which the authentication device 11 is set as one side while the authentication device 11 is set as the other side.

The authentication processing part 22 transmits original random-number data (constituted of at least a random number) generated from the random-number generation circuit 6b as initial communication random-number data without encrypting. At this time, the authentication processing part 22 selects one encryption key as a new selection encryption key SCKb from the encryption keys Cki1 to CKin in the selection key bundle SBK in accordance with the association based on the received original random-number data and stores selection authenticating key information indicating the selection authenticating key SCKb in the nonvolatile memory 4b.

When the authentication processing part 21 receives the original random-number data as the initial communication random-number data, it selects an encryption key as a new encryption key SCKa from the encryption keys Cki1 to CKin in the selection key bundle SBK following the above-mentioned interrelation (same interrelation as used by the authentication processing part 22) based on the received original random-number data, stores it in the information nonvolatile memory 4a indicating the selection authenticating key SCKa and requests the encryption/decryption circuit 5a to encrypt.

After receiving the encryption request, the encryption/decryption circuit 5a executes encryption response of generating a encrypted random number by encrypting the random-number data received using new selection encryption key SCKa. Then, the authentication processing part 21 transmits encrypted random-number data to the authentication processing part 22.

After receiving the encrypted random-number data, the authentication processing part 22 requests the encryption/decryption circuit 5b to decrypt the encrypted random number.

After receiving the decryption request, the encryption/decryption circuit 5b executes decryption response of generating the decrypted random-number data by decrypting the encrypted random-number data using the selection encryption key SCKb selected in the second encryption key authenticating process 32.

The authentication processing part 22 executes determining process 34 based on comparison of original random-number data which is data at the time of transmission and decrypted random-number data. Hereinafter the determining process will be described.

If the original random-number data and the decrypted random-number data coincide, the authentication processing part 22 determines that the selection encryption key SCKb of the authentication processing part 22 in the second authentication key authenticating process 32 and the selection encryption key SCKa of the authentication processing part 21 coincide and determines that the authentication is acceptable as a result of authentication. On the other hand, unless the original random-number data and decrypted random-number data coincide, the authentication processing part 22 determines that the selection encryption key SCKb of the authentication processing part 22 and the selection encryption key SCKa of the authentication processing part 21 do not coincide and determines that the authentication is unacceptable as a result of the authentication.

After the above-mentioned process, the second encryption key authenticating process 32 is ended. If it is determined that the authentication is acceptable in both the first encryption key authenticating process 31 and the second encryption key authenticating process 32, the authentication is successful, thereby confirming that data transmission and reception can be carried out between the authentication device 1 and the authentication device 12 according to common key encryption method using a common key of selection key bundle.

If it is determined that the authentication is unacceptable in the first encryption key authenticating process 31 or the second encryption key authenticating process 32, the authentication fails and the authenticating process (30 to 32) is executed again. The authentication is executed until the authentication is successful and if authentication failure is repeated by predetermined times, functional restriction, for example, disabling communication is carried out.

According to the first embodiment, if the selection encryption key CKis to be selected by the encryption keys Cki1 to CKin in the selection key bundle SBK is automatically determined between the authentication devices 11 and 12 based on random-number data to be sent, the selection random number key CKis can be automatically changed for each authenticating process. For the reason, a risk that an encryption key may be specified at the time of execution of the authenticating process is decreased largely so that authentication having a security heightened with respect to an attack by a third party can be carried out without complicatedness.

Additionally, because exchange of encrypted data is executed only when the abovementioned authenticating process succeeds, there occurs no trouble in data transmission and reception.

Further, by executing the first authentication key authenticating process 32 to the authentication device 12 by the authentication device 11 and the second authentication key authenticating process 32 to the authentication device 11 by the authentication device 12 in parallel, authentication accuracy can be raised. In the meantime, an embodiment in which any one of the first authentication key authenticating process 31 and the second authentication key authenticating process 32 is omitted can be considered although the authentication accuracy drops slightly.

Further, because according to the first embodiment, double selection is executed by selecting one key bundle from the key bundle group 13 and next selecting one selection encryption key CKis from the selected key bundle, it is extremely difficult to recognize the selection encryption key CKis from the third party, thereby further raising the security against attack by the third party.

By transmitting the original random-number data as initial communication random-number data transmission and reception of the random-number data can be carried out easily.

(Others)

FIG. 16 is an explanatory diagram showing key bundle groups 15, 16 stored in the nonvolatile memory 4 of each of the authentication devices 11, 12 for use in the first embodiment. As indicated in FIG. 16, a key bundle group 15 is stored in the nonvolatile memory 4 on the side of the authentication device 11 and the key bundle group 15 has m (≧2) encryption key BK1 to BKm like the key bundle group 13 shown in FIG. 3. On the other hand, the authentication processing part 22 of the authentication device 12 has a key bundle group 16 having the same structure as the key bundle group 15.

The key bundle groups 15, 16 have initial encryption keys 35, 36 in common. They are different from the key bundle groups 13, 14 in this point. For convenience for explanation, the aforementioned authenticating process using the key bundle groups 13, 14 is called a basic authenticating process and an authenticating process described later using the key bundle groups 15, 16 is called an authenticating process of other example.

Hereinafter the authenticating process of the other example will be described with reference to FIG. 4 about mainly a difference to the basic authenticating process. First, the selection key bundle determining process 30, which is the authenticating process of the other example is carried out in the same way as the basic authenticating process.

After the selection key bundle determining process 30 is ended, the first encryption key authenticating process 31 is carried out. The authentication processing part 21 encrypts original random-number data generated from the random-number generation circuit 6a to obtain initial communication random-number data and transmits this initial communication random-number data to the authentication processing part 22. At this time, the authentication processing part 21 selects an encryption key from the encryption keys Cki1 to CKin in the selection key bundle SBK as the selection encryption key SCKa in accordance with the association determined preliminarily based on random-number data and stores selection authenticating key information indicating the selection authenticating key SCKa in the nonvolatile memory 4a.

The authentication processing part 22, after receiving the initial communication random-number data, executes initial random-number recognition method of decrypting initial communication random-number data using the initial encryption key 36 of the key bundle group 16 so as to obtain random-number data. A encryption key is selected as the selection encryption key SCKb from the encryption keys Cki1 to CKin in the selection key bundle SBK following the above-mentioned interrelation (the same interrelation as used by the authentication processing part 21) based on this random-number data and stored in the information nonvolatile memory 4b indicating the selection authenticating key SCKb so as to request the encryption/decryption circuit 5b to encrypt it.

Because the content of other process of the first authentication key authenticating process 31 is carried out in the same way as the basic authenticating process, description thereof is omitted. If the first encryption key authenticating process 31 is ended, the procedure proceeds to the second encryption key authenticating process 32.

The authentication processing part 22 encrypts original random-number data generated from the random-number generation circuit 6b using the initial encryption key 36 of the key bundle group 16 so as to obtain the initial communication random-number data and transmits this initial communication random-number data to the authentication processing part 21. At this time, the authentication processing part 22 selects an encryption key from the encryption keys CKi1 to CKim in the selection key bundle SBK as new selection encryption key SCKb in accordance with the association based on the random-number data and stores the selection authenticating key information indicating the selection authenticating key SCKb in the nonvolatile memory 4b.

The authentication processing part 21, after receiving the initial communication random-number data, executes the initial random-number recognition method of decrypting the initial communication random-number data using the initial random number key 35 of the key bundle group 15 so as to obtain the random-number data. A encryption key is selected as the selection encryption key SCKa from the encryption keys CKi1 to CKin in the selection key bundle SBK following the above-mentioned interrelation (the same interrelation as used by the authentication processing part 22) based on this random-number data and stored in the information nonvolatile memory 4a indicating the selection authenticating key SCKa so as to request the encryption/decryption circuit 5a to encrypt it.

Because the content of other process of the second authentication key authenticating process 32 is carried out in the same way as the basic authenticating process, description thereof is omitted. Processing accompanying the authentication result of the first encryption key authenticating process 31 and the second encryption key authenticating process 32 is carried out in the same way as the basic authenticating process.

According to the authenticating process of the other example, like the basic authenticating process, the security against an attack by the third party can be intensified by transmitting data obtained by encrypting the original random-number data with the initial encryption keys 35, 36 as the initial communication random-number data without transmitting the original random-number data.

### Second Embodiment

FIG. 5 is a block diagram showing the structure of an authentication device for use in the authentication method according to the second embodiment of the present invention. As indicated in FIG. 5, the authentication device 11 includes an authentication processing part 21, a transmission/reception part 23 and a clock function 25 as indispensable constituent elements. As for the hardware structure, this embodiment is different from the first embodiment in that the clock function 25 is added. In the meantime, the authentication device 12 includes an authentication processing part 22, a transmission/reception part 24 and a clock function 26.

With such a structure, the authenticating process (including the basic authenticating process and authenticating process of other example) is executed in the same way as the first embodiment. However, only the determination method for the selection encryption key SCKa and selection encryption key SCKb in the first and second encryption key authenticating processes 31, 32 are different.

The selection encryption key SCKa (SCKb) is determined based on an authentication start time at a timing determined preliminarily during the authenticating process such as transmission time of original random-number data (initial communication random-number data) and the like. For example, if eight encryption keys Cki1 to CKin (n=8) exist, an interrelation of converting the random-number data transmission time to 3 bits according to a predetermined calculation equation and selecting any of the encrypts Cki1 to CKi8 based on the 3-bit value can be considered.

The random-number data transmission time can be made common by transmitting the time stamp information from the authentication device 11 to the authentication device 12 when random-number data is transmitted.

Further, if the clock function 25 of the authentication device 11 and the clock function 26 of the authentication device 12 have electric wave clock function so that accurate time can be always counted, the selection encryption key SCKa can be determined without transmitting following time stamp information.

For example, the authentication processing parts 21, 22 can match the transmission time information portion and the reception time information portion of an object to be interrelated accurately by extracting the transmission time information portion and reception time information portion which allow a difference in time between random-number data transmission time and random-number data reception time to be neglected when the 3-bit data is handled. As a result, the authentication processing part 21 can select the selection encryption key SCKa based on the transmission time information portion and the authentication processing part 22 selects the selection encryption key SCKb based on the reception time information portion so as to execute the first encryption key authenticating process 31 without any trouble. Then, the authentication processing part 22 selects the selection encryption key SCKb based on the transmission time information portion and the authentication processing part 21 selects the selection encryption key SCKa based on the reception time information portion so as to execute the second encryption key authenticating process 32 without any trouble.

In case where it is constructed that the authentication device 11 acts as master while the authentication device 12 acts as slave and a difference in signal exchange time between the authentication devices 11 and 12 can be neglected, it is permissible to determine the selection encryption key SCKa and selection encryption key SCKb by means of the authentication processing parts 21, 22, with a timing for the authentication device 11 acting as the master to reset the authentication device 12 acting as slave as a starting point and a time from the reset time to an authentication start time as authentication time for the both.

Because the selection encryption key is changed for each authenticating process by selecting the selection encryption key from a plurality of encryption keys based on authentication time which can be identified, risk that the selection encryption key may be interpreted at the time of authentication is reduced largely, and consequently, the same effect as the first embodiment is exerted, so that, for example, an authenticating process having a security intensified against attack by the third party can be carried out.

The security against attack by the third party can be further intensified by using a determination method for the selection encryption key SCKa which does not need transmission of the aforementioned time stamp information.

As for the content of the authenticating process, an embodiment in which any one of the first authentication key authenticating process 31 and the second authentication key authenticating process 32 is omitted can be considered although the authentication accuracy drops slightly. Further, it is permissible to execute at least one of the first authentication key authenticating process 31 and the second authentication key authenticating process 32 for only one key bundle by omitting the selection key bundle determining process 30.

According to the second embodiment, the basic authenticating process in which the initial communication random-number data is regarded as the original random-number data itself has been described as the authenticating process. Needless to say, this embodiment can be applied to an authenticating process of other example in which data obtained by encrypting the original random-number data with the initial encryption key is regarded as the initial communication random-number data.

### Third Embodiment

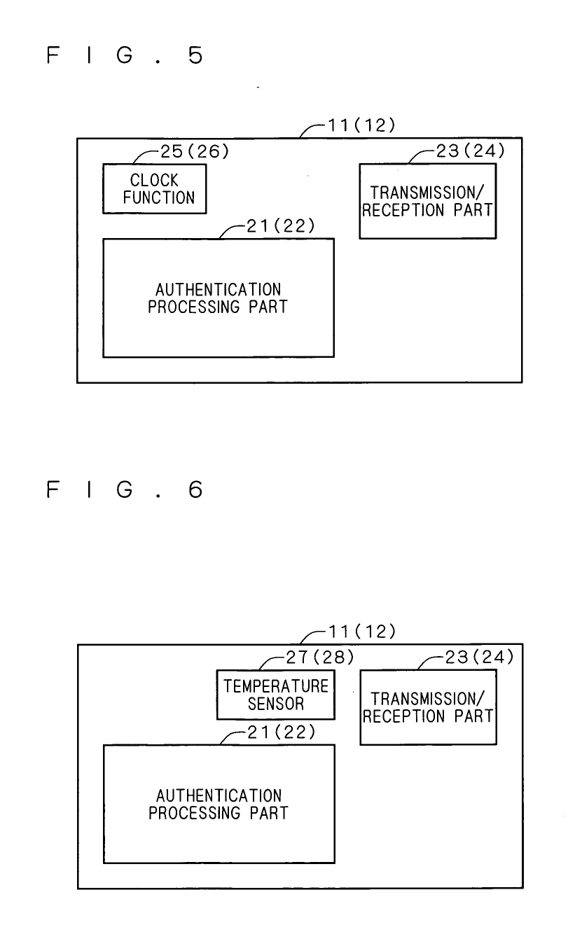

FIG. 6 is a block diagram showing the structure of an authentication device for use in the authentication method according to the third embodiment of the present invention. As indicated in FIG. 6, the authentication device 11 includes an authentication processing part 21, a transmission/reception part 23 and a temperature sensor 27 as indispensable constituent elements. As for the hardware structure, this embodiment is different form the first embodiment in that the temperature sensor 27 is added. In the meantime, the authentication device 12 includes an authentication processing part 22, a transmission/reception part 24 and a temperature sensor 28.

With such a structure, the authenticating process (including the basic authenticating process and authenticating process of other example), the authenticating process is carried out in the same way as the first embodiment. However, only the selection encryption key SCKa and selection encryption key SCKb in the first and second encryption key authenticating processes 31, 32 are different.

The selection encryption key SCKa (SCKb) is determined based on an authentication start time at a timing determined preliminarily during the authenticating process such as transmission time of original random-number data (initial communication random-number data) and the like. For example, if eight encryption keys CKi1 to CKin (n=8) exist, a method of converting a detection temperature at the time of random-number data transmission to 3 bits according to a predetermined calculation equation and selecting any of the encrypts CKi1 to CKi8 based on that 3-bit value can be considered.

The detection temperature at the time of random-number data transmission can be made common between the authentication devices 11 and 12 by transmitting the detection temperature to the authentication device 12 when the random-number data is transmitted from the authentication device 11 to the authentication device 12.

In case of a structure in which the authentication device 11 and authentication device 12 are disposed in the vicinity of each other and the temperature sensor 27 (28) can be shared between the authentication device 11 and the authentication device 12, the selection encryption key SCKa can be determined without transmitting any detection temperature.

For example, the authentication processing parts 21, 22 can match the transmission time detection temperature information and the reception time detection temperature information by extracting the detection temperature which allow a difference in time between random-number data transmission time and random-number data reception time to be neglected when the 3-bit data is handled. As a result, the authentication processing part 21 can select the selection encryption key SCKa based on the transmission time detection temperature and the authentication processing part 22 selects the selection encryption key SCKb based on the reception time detection temperature so as to execute the first encryption key authenticating process 31. Then, the authentication processing part 22 selects the selection encryption key SCKb based on the transmission time detection temperature and the authentication processing part 21 selects the selection encryption key SCKa based on the reception time detection temperature so as to execute the second encryption key authenticating process 32.

Because the selection encryption key is changed for each authenticating process by selecting the selection encryption key from a plurality of encryption keys based on authentication temperature which can be identified, risk that the selection encryption key may be interpreted at the time of authentication is reduced largely, and consequently, the same effect as the first embodiment is exerted, so that, for example, authenticating process having a security intensified against attack by the third party can be carried out.

The security against attack by the third party can be further intensified by using a determination method for the selection encryption key SCKa which does not need transmission of the aforementioned detection temperature information.

As for the content of the authenticating process, an embodiment in which any one of the first authentication key authenticating process 31 and the second authentication key authenticating process 32 is omitted can be considered although the authentication accuracy drops slightly. Further, it is permissible to execute at least one of the first authentication key authenticating process 31 and the second authentication key authenticating process 32 for only one key bundle by omitting the selection key bundle determining process 30.

According to the third embodiment, the basic authenticating process in which the initial communication random-number data is regarded as the original random-number data itself has been described as the authenticating process. Needless to say, this embodiment can be applied to the authenticating process of other example in which data obtained by encrypting the original random-number data with the initial encryption key is regarded as the initial communication random-number data. In the meantime, the authentication device 11 and the authentication device 12 described in the first to third embodiments may be constructed as a semiconductor device.

### Fourth Embodiment

FIG. 7 is a block diagram showing part of the structure of the authentication system of an electric vehicle according to the fourth embodiment of the present invention. As shown in FIG. 7, an electric bicycle 45, which is a control object, includes an electric vehicle key 41, a battery 42 and a drive part 46. The drive part 46 can be operated by receiving power from the battery 42. The aforementioned bicycle 41 and the battery 42 are constituent elements.

As an authentication method for use between the electric bicycle 41 and the battery 42, any one of the authentication methods of the first to third embodiments is adopted and after authentication succeeds as a result of authentication result of this authentication method, supply of power from the battery 42 to the drive part 46 is validated so that use of the electric bicycle is enabled.

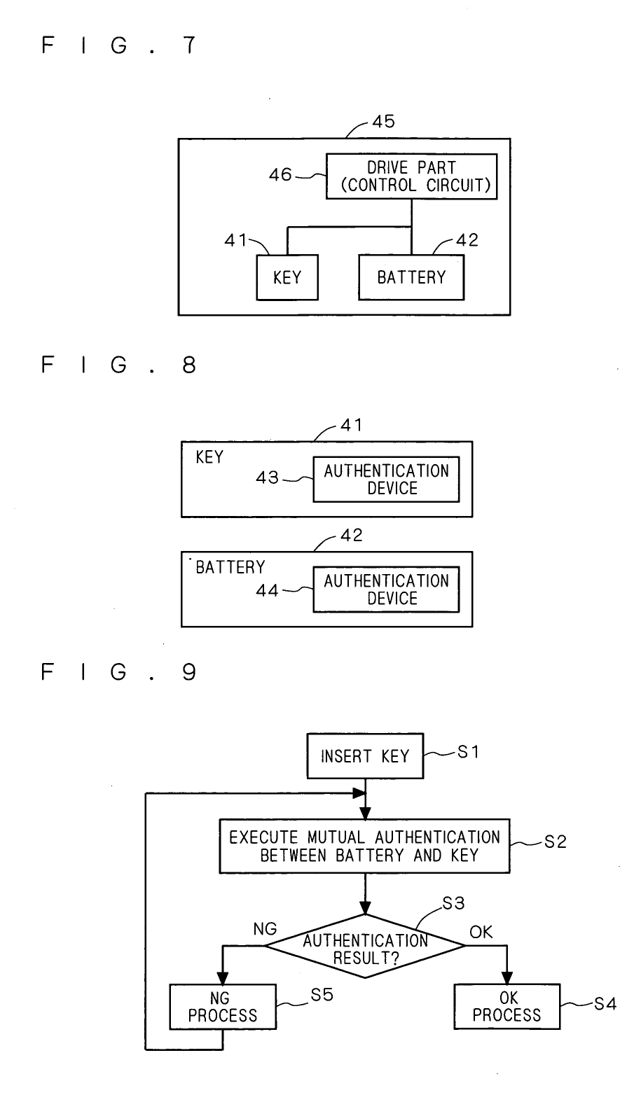

FIG. 8 is an explanatory diagram showing the internal structure of the electric bicycle 41 and the battery 42. As indicated in FIG. 8, the electric bicycle 41 and the battery 42 include an authentication device 43 and an authentication device 44. In the meantime, the content of key bundle group possessed between the electric bicycle 41 and the battery 42 is inherent of each electric bicycle.

The aforementioned authentication devices 43, 44 correspond to the authentication devices 11, 12 according to any one of the first to third embodiments.

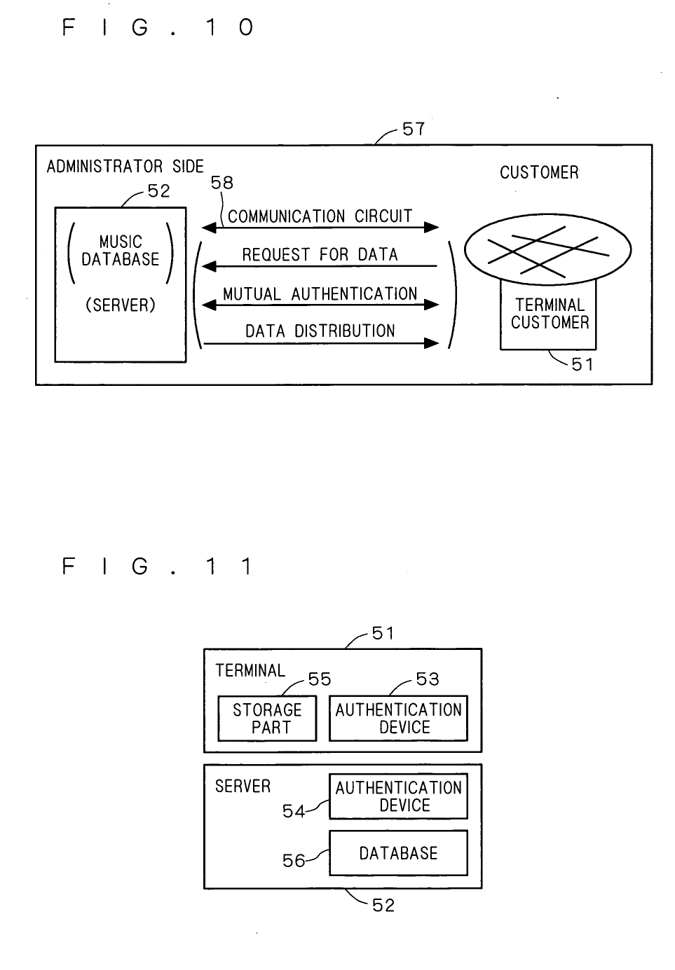

FIG. 9 is a flowchart showing authentication controlling process between the electric bicycle 41 and the battery 42 of the electric bicycle of the fourth embodiment. The authentication controlling process shown in FIG. 9 is carried out when the CPU 1a(1b) in the authentication device 43 (44) executes an electric bicycle authentication controlling process program stored in program ROM 3a (3b).

Referring to FIG. 9, first, when user inserts the electric bicycle key 41 into a key hole provided in the electric bicycle in step S1, the aforementioned authentication controlling process is started.

In step S2, a mutual authenticating process is carried out between the electric bicycle 41 and the battery 42. This mutual authenticating process is carried out under the same content as the authenticating process (selection key bundle determining process 30, first encryption key authenticating process 31 and second encryption key authenticating process 32) as any one of the first to third embodiments.

Then, in step S3, an authentication result is verified and if the authentication succeeds, the procedure proceeds to step S4 and if it fails, the procedure proceeds to step S5.

In step S4 executed when the authentication succeeds, the supply of power from the battery 42 to the drive part 46 is validated and an OK process, which enables driving (enables a predetermined operation to be executed) of the electric bicycle 45 as a driving object, is carried out.

On the other hand, in step S5 executed when the authentication fails, a variety of NG processes are executed. The NG processes include turning the drive part 46 into charge mode (processing in which load is applied to a pedal), blinking light, dispatching an alarm sound and the like.

After step S5 is executed, the procedure returns to step S2, in which the mutual authenticating process is restarted and until it is verified that the authentication succeeds in step S3, step S4 is never executed, so that the supply of power from the battery 42 to the drive part 46 is not validated.

As described above, the authentication system of the electric bicycle of the fourth embodiment is so constructed that the electric bicycle cannot be used actually until the mutual authenticating process between the electric bicycle key 41 and the battery 42 succeeds.

Therefore, even if other person steals only the battery 42 from the electric bicycle 45 and tries to use it as a battery of other electric bicycle of the same specification, authentication fails in mutual authenticating process between the electric bicycle key and battery, so that it cannot be used actually. Further, by verifying that the mutual authenticating process fails, it can be estimated objectively that the electric bicycle 41 or the battery 42 was acquired by illegal means such as stealing.

By executing a treatment of applying a load on the pedal in the NG process, the function of the electric bicycle is limited and if the mutual authenticating process fails, by providing inconvenience to use as an ordinary bicycle, use of a stolen battery by other person is made more difficult.

Further, because an owner can be managed by writing his inherent identification information (recycle information) into the program ROM 3 or the nonvolatile memory 4 in the authentication device 44 of the battery 42, illegal dumping can be prevented.

### Fifth Embodiment

FIG. 10 is a block diagram showing part of the structure of a communication karaoke system according to the fifth embodiment of the present invention. As indicated in FIG. 10, in the communication karaoke system 57, which is a control object (system), a terminal 51 on customer side and a server 52 on administrator side are connected through a communication line 58 so that data transmission and reception is enabled.

The aforementioned terminal 51 and server 52 are constituent elements. Although FIG. 10 indicates the terminal 51 and the server 52 in one-to-one relation, actually, a single server 52 corresponds to a plurality of terminals 51.

Data distribution including download of music data (song data and the like) from the server 52 to the terminal 51 corresponding to data demand from the terminal 51 to the server 52 is not validated until the authentication between the terminal 51 and the server 52 succeeds. At this time, as an authentication method between the terminal 51 and the server 52, any one of the first to third embodiments is adopted.

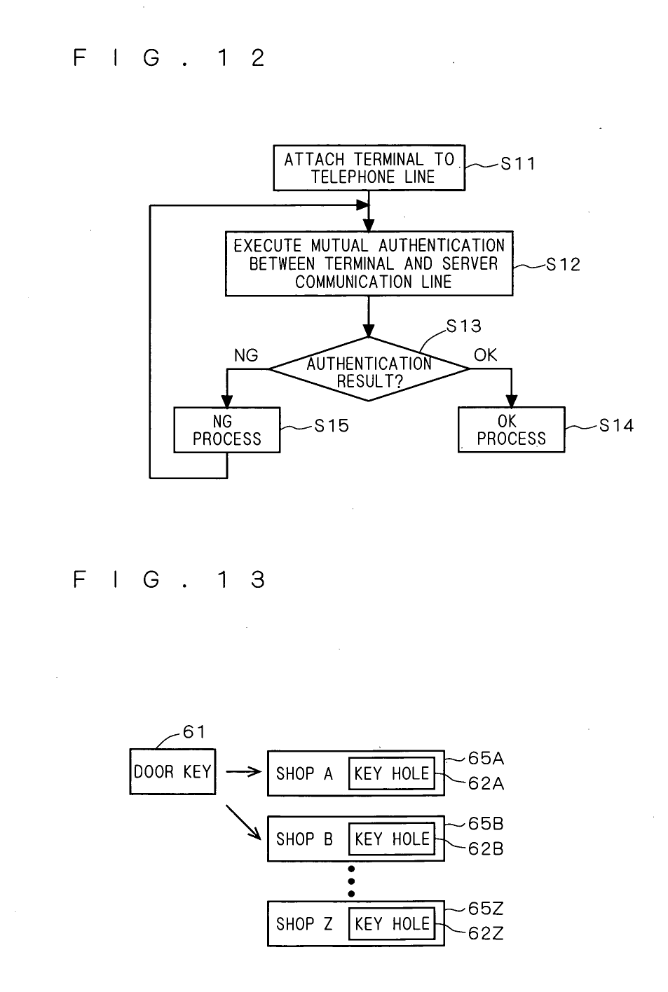

FIG. 11 is an explanatory diagram showing the internal structure of the terminal 51 and server 52 shown in FIG. 10. As indicated in FIG. 11, the terminal 51 has an authentication device 53 and a storage part 55 for storage of music data and the server 52 has an authentication device 54 and a database 56 for music data. Then, the authentication devices 53, 54 correspond to the authentication devices 11, 12 according to any one of the first to third embodiments.

The server 52 possesses all key bundle groups each having a plurality of terminals 51 which can be connected internally (nonvolatile memory 4 inside the authentication device 12) and on the other hand, the content of the key bundle groups differs among the plurality of terminals 51. That is, each terminal 51 has at least an inherent key bundle group and the server 52 has key bundle groups for all the terminals 51.

FIG. 12 is a flowchart showing authentication operation between a terminal 51 (of a plurality of terminals 51, a single terminal which demands for data distribution from the server 52) and the server 52 of the communication karaoke system according to the fifth embodiment. The authentication operation shown in FIG. 12 is carried out when the CPU 1a (1b) in the authentication device 53 (54) executes the communication karaoke authentication control program stored in the program ROM 3a (3b).

Referring to FIG. 12, the terminal 51 and the server 52 are connected electrically through a communication line when user loads the terminal 51 onto telephone line in step S11. With this condition, the above-mentioned authentication operation is started.

Then, in step S12, a mutual authenticating process between one terminal 51 and the server 52 is carried out. This mutual authenticating process is executed under the same content as the authenticating process (selection key bundle determining process 30, first encryption key authenticating process 31 and second encryption key authenticating process 32) of any one of the first to third embodiments. At this time, the authentication device 53 of the terminal 51 corresponds to the side of the authentication device 11 in FIG. 4 and the authentication device 54 of the server 52 corresponds to the side of the authentication device 12. Further, in the selection key bundle determining process 30, a key bundle possessed by one terminal 51 is selected as a selection key bundle.

In step S13, an authentication result is verified and if the authentication succeeds, the procedure proceeds to step S14 and if the authentication fails, the procedure proceeds to step S15.

In step S14 executed when the authentication succeeds, data distribution from the server 52 to the terminal 51 is validated, so that user at the terminal 51 can receive distribution of a desired music data from the server 52 as a result of demand for the data distribution. That is, the OK process which enables the communication karaoke system 57 to perform a predetermined operation is carried out.

On the other hand, in step S15 executed when the authentication fails, various NG processes are carried out. The NG process includes disabling data distribution, notifying an administrator of the server 52 of illegal access, notifying user of the terminal 51 of information indicating that the mutual authentication is impossible, invalidating data in the storage part 55 of the terminal 51 and the like.

After step S15 is executed, the procedure returns to step S12 again and step S14 is not executed until the mutual authenticating process is restarted and it is verified that the authentication succeeds in step S13. No data distribution is carried out from the server 52 to the terminal 51.

Because according to the authentication system of the communication karaoke system 57 of the fifth embodiment, the communication karaoke system 57 cannot start a predetermined operation such as data distribution until mutual authenticating process between the terminal 51 and the server 52 succeeds, the mutual authenticating process can be executed rapidly and accurately in the communication karaoke system in which a plurality of terminals 51 and a server 52 are provided correspondingly.

Thus, even if a third party accesses the server 52 illegally using a same device as the terminal 51 of the communication karaoke system 57, authentication fails in the mutual authenticating process between the terminal and the server, so that the communication karaoke system 57 is impossible to operate properly. Further, because the encryption key for use in the mutual authenticating process changes for each processing, security against illegal access to the server 52 by illegal acquisition of an encryption key is high.

Further, by limiting the function of the communication karaoke system 57 by, for example, invalidating data in the storage part 55 of the terminal 51 in the NG process so as to make a terminal of user who tries to user illegally inconvenient for use, the illegal use by the third party can be inhibited effectively.

Because the mutual authenticating process is basically executed automatically between the authentication device 53 of the terminal 51 and the authentication device 54 of the server 52, there is little labor and time required for authenticating process when user of a proper terminal 51 receives data distribution from the server 52.

Because the terminal 51 of each user does not need to be provided with any identification information such as a control number, the side of the server 52 does not need to manage any identification information but only needs to control the key bundle of the encryption keys.

### Sixth Embodiment

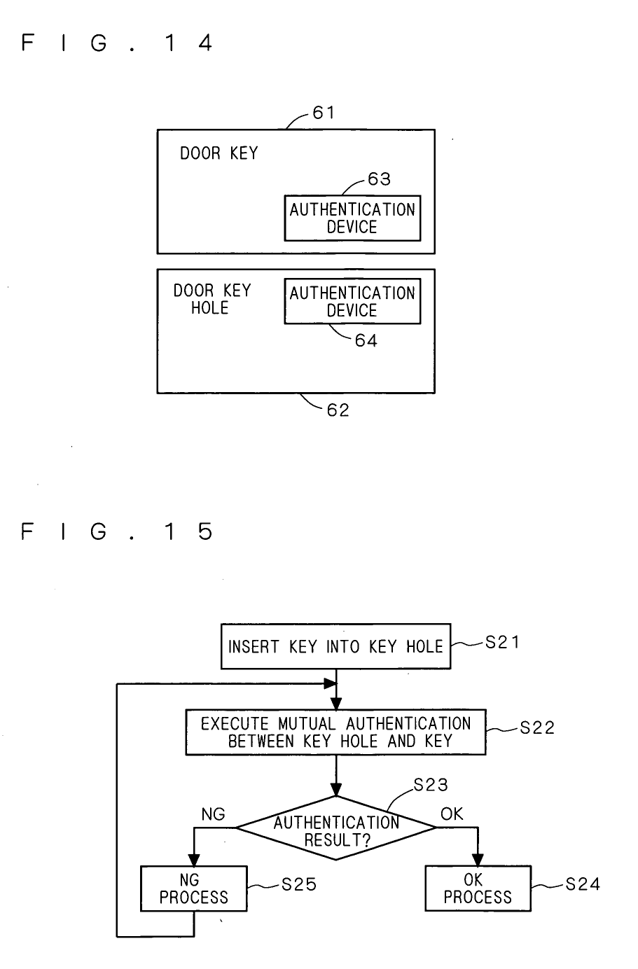

FIG. 13 is a block diagram showing part of the structure of the authentication system for shop groups according to the sixth embodiment of the present invention. As indicated in FIG. 13, the shop group, which is a control object, is a plurality of shops 65A to 65Z and they have key holes 62A to 62Z having a common physical structure. A door key 61 is inserted into a door key hole 62 and when the mutual authenticating process between the door key 61 and the door key hole 62 succeeds, the door is opened. The aforementioned door key 61 and door key hole 62 are constituent elements.

FIG. 14 is an explanatory diagram showing the internal structure of the door key 61 and door key hole 62 shown in FIG. 13. As indicated in FIG. 14, the door key 61 has an authentication device 63 and the door key hole 62 has an authentication device 64. These authentication devices 64, 63 correspond to the authentication devices 11, 12 according to any one of the first to third embodiments.

Then, the door of the shop 65 cannot be opened until the authenticating process between the door key 61 and the door key hole 62 succeeds. At this time, as the authentication method between the door key 61 and the door key hole 62, the authentication method according to any one of the first to third embodiments is adopted.

The door key 61 can be inserted into door key holes 62A to 62Z of a plurality of shops 65A to 65Z and the content of the key bundle group differs between the plurality of door key holes 62A to 62Z. The door key 61 has a key bundle group corresponding to the shop 65 whose door is allowed to be opened/closed of the plurality of shops 65A to 65Z. According to an example shown in FIG. 13, the door key 61 has a common key bundle group to the key bundle group of the shops 65A, 65.

That is, each door key hole 62 has at least an inherent key bundle group and the door key 61 has only a key bundle group for all the door key holes 62 corresponding to the shop 65 whose door is allowed to be opened/closed. As a consequence, the door key hole 62 and door key 61 have a multiple-to-one relation or one-to-one relation.

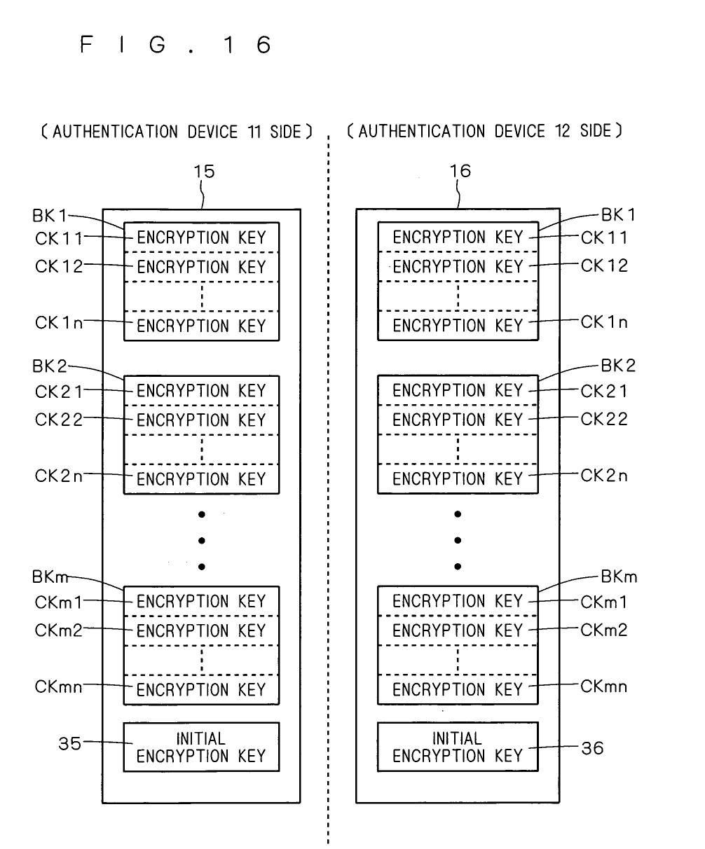

FIG. 15 is a flowchart showing the content of the authentication controlling process between the door key hole 62 and the door key 61 in the authentication system for shops according to the sixth embodiment. The authentication controlling process shown in FIG. 15 is carried out when the CPU 1a (1b) in the authentication device 63 (64) executes a shop group authentication controlling process program stored in the program ROM 3a (3b).

Referring to FIG. 15, if user, for example, vehicle driver who wants to use the shop, inserts the door key 61 into the door key hole 62 in step S21, the door key hole 62 and the door key 61 are electrically connected. With this condition, the abovementioned authentication controlling process is started.

In step S22, the mutual authenticating process is carried out between the door key portion 62 and the door key 61. This mutual authenticating process is carried out with the same content as authenticating process (selection key bundle determining process 30, first encryption key authenticating process 31 and second encryption key authenticating process 32) according to any one of the first to third embodiments. At this time, the authentication device 64 in the door key hole 62 corresponds to the authentication device 11 of FIG. 4 and the authentication device 63 in the door key 61 corresponds to the authentication device 12 of FIG. 4. For the selection key bundle determining process 30, a key bundle possessed by the door key hole 62 in which the door key 61 is inserted is selected as a selection key bundle.

In step S23, authentication result is verified and if the authentication succeeds, the procedure proceeds to step S24 and if the authentication fails, the procedure proceeds to step S25.

In step S24 executed when the authentication succeeds, the door of a given shop is opened. That is, the OK process which makes possible a predetermined operation of a shop group, which is an operation object, is carried out.

On the other hand, in step S25 executed when the authentication fails, a variety of NG processes are carried out. The NG process includes inhibiting the door from being opened, notifying illegal invasion into shop using lighting, sound or the like.

After step S25, the procedure returns to step S22, in which the mutual authenticating process is restarted. Step S24 is not executed until it is confirmed that the authentication succeeds in step S23, so that the shop door is not opened.

According to the authentication system for shop group of the sixth embodiment, the shop door cannot be opened until the mutual authenticating process between the door key hole 62 and the door key 61 succeeds.

Even if the third party tries to invade illegally into a desired shop 65 in the shop group using a key having the same physical structure as the door key 61, the mutual authenticating process between the door key 61 and the door key hole 62 fails, so that he cannot invade. Because the encryption key used for the mutual authenticating process is changeable, even if the third party obtains illegally, a high security against such an invasion is kept.

By notifying an illegal invasion into a shop through the NG process, an illegal invader can be specified relatively easily.

The door key 61 which user should possess may be physically single and a desired purpose can be achieved sufficiently if a key bundle group for the shop whose door can be opened is memorized in the authentication device 63. Even if the door key 61 is lost, a risk that a third party may invade into the shop can be avoided securely by changing the content of the key bundle group of the door key hole 62 of the shop even if the third party acquires that lost door key 61.

While the invention has been shown and described in detail, the foregoing description is in all aspects illustrative and not restrictive. It is therefore understood that numerous modifications and variations can be devised without departing from the scope of the invention.

What is claimed is:

1. An authentication method for authenticating commonality of encryption keys possessed by first and second authentication devices, wherein
each of said first and second authentication devices includes:
an authentication processing part for executing an authenticating process; and
a transmission/reception part for transmitting and receiving data at the time of said authenticating process,
said authentication processing part includes:
an authenticating process control part for executing and controlling said authenticating process;
a storage part for storing a key bundle having a plurality of encryption keys, each of said key bundles containing a predetermined number of key bundles each having a plurality of encryption keys;
an encryption/decryption circuit for encrypting and decrypting data using a selection encryption key; and
a random-number generation circuit for generating random-number data, and
said authenticating process is executed in such a state that data transmission and reception via each transmission/reception part is enabled with the first authentication device as one side and the second authentication device as the other side, and includes the steps of:
(a) recognizing a selection key bundle which is one key bundle contained in said predetermined number of key bundles by data transmission and reception between said one side and said other side;
(b) transmitting initial communication random-number data based on original random-number data which is random-number data generated from said authentication processing part from said one side to said other side, said one side executing a predetermined association based on said original random-number data to select one encryption key from said plurality of encryption keys in said selection key bundle as a selection encryption key for the one side;
(c) receiving the initial communication random-number data on said other side, acquiring the original random-number data from said initial communication random-number data using an initial random-number recognition method, executing said predetermined association based on the original random-number data to select one encryption key from said plurality of encryption keys in said selection key bundle as a selection encryption key for the other side, acquiring encrypted random-number data by encrypting said original random-number data using the selection encryption key for the other side, and transmitting the encrypted random-number data to said one side;
(d) receiving said encrypted random-number data on said one side, and acquiring decrypted random-number data by decrypting said encrypted random-number data using said selection encryption key for the one side; and
(e) comparing said original random-number data with said decrypted random-number data on said one side and determining whether or not an authentication result is acceptable depending on whether the comparison result is consistent or inconsistent.

2. An authentication method for authenticating commonality of encryption keys possessed by first and second authentication devices, wherein
each of said first and second authentication devices includes:
an authentication processing part for executing an authenticating process;
a transmission/reception part for transmitting and receiving data at the time of said authenticating process; and
a clock function,
said authentication processing part includes:
an authenticating process control part for executing and controlling said authenticating process;
a storage part for storing a key bundle having a plurality of encryption keys;
an encryption/decryption circuit for encrypting and decrypting data using a selection encryption key; and
a random-number generation circuit which generates random-number data, and
said authenticating process is executed in such a state that data transmission and reception via each transmission/reception part is enabled with the first authentication device as one side and the second authentication device as the other side, and includes the steps of:
(b) transmitting initial communication random-number data based on original random-number data which is random-number data generated from said authentication processing part from said one side to said other side, said one side executing a predetermined association based on an authentication time for the one side at a predetermined timing in said authenticating process to select one encryption key from said plurality of encryption keys in said key bundle as a selection encryption key for the one side;
(c) receiving said initial communication random-number data on said other side, acquiring said original random-number data from said initial communication random-number data using an initial random-number recognition method, executing said predetermined association based on an authentication time for the other side capable of being identified with said authentication time for the one side to select one encryption key from said plurality of encryption keys in said key bundle as a selection encryption key for the other side, acquiring encrypted random-number data by encrypting said original random-number data using the selection encryption key for the other side, and transmitting the encrypted random-number data to said one side;
(d) receiving said encrypted random-number data on said one side, and acquiring decrypted random-number data by decrypting said encrypted random-number data using said selection encryption key for the one side; and
(e) comparing said original random-number data with said decrypted random-number data on said one side and determining whether or not an authentication result is acceptable depending on whether the comparison result is consistent or inconsistent.

3. The authentication method according to claim 2 wherein
said authentication time for the one side includes a transmission time of said initial communication random-number data in said step (b),
said authentication time for the other side includes a reception time of said initial communication random-number data in said step (c), and
said predetermined association includes an association based on time information not affected by a delay time generated by transmission/reception of said initial communication random-number data in time information acquired from said transmission time and time information acquired from said reception time.

4. An authentication method for authenticating commonality of encryption keys possessed by first and second authentication devices, wherein
each of said first and second authentication devices includes:
an authentication processing part for executing an authenticating process;
a transmission/reception part for transmitting and receiving data at the time of said authenticating process; and
a temperature sensor capable of measuring a temperature of a device as a detection temperature,
said authentication processing part includes:
an authenticating process control part for executing and controlling said authenticating process;
a storage part for storing a key bundle having a plurality of encryption keys;
an encryption/decryption circuit for encrypting and decrypting data using a selection encryption key; and
a random-number generation circuit for generating random-number data, and
said authenticating process is executed in such a state that data transmission and reception via each transmission/reception part is enabled with the first authentication device as one side and the second authentication device as the other side, and includes the steps of:
(b) transmitting initial communication random-number data based on original random-number data which is random-number data generated from said authentication processing part from said one side to said other side, said one side executing a predetermined association based on a detection temperature on the one side detected by said temperature sensor at a predetermined timing during said authenticating process to select one encryption key from said plurality of encryption keys in said selection key bundle as a selection encryption key for the one side;
(c) receiving said initial communication random-number data on said other side, acquiring said original random-number data from said initial communication random-number data using an initial random-number recognition method, executing said predetermined association based on a detection temperature on the other side capable of being identified with said detection temperature on the one side to select one encryption key from said plurality of encryption keys in said selection key bundle as a selection encryption key for the other side, acquiring encrypted random-number data by encrypting said original random-number data using the selection encryption key for the other side, and transmitting the encrypted random-number data to said one side;
(d) receiving said encrypted random-number data on said one side, and acquiring decrypted random-number data by decrypting said encrypted random-number data using said selection encryption key for the one side; and
(e) comparing said original random-number data with said decrypted random-number data on said one side and determining whether or not an authentication result is acceptable depending on whether the comparison result is consistent or inconsistent.

5. The authentication method according to claim 4, wherein
said detection temperature for the one side includes a transmission time detection temperature which is a detection temperature at the time of transmission of said initial communication random-number data in said step (b),
said step (b) includes a step of transmitting said transmission time detection temperature together with said initial communication random-number data,
said step (c) receives said transmission time detection temperature together with said initial communication random-number data, and
said detection temperature for the other side includes said transmission time detection temperature.

6. The authentication method according to claim 2, wherein
said key bundle includes a predetermined number of key bundles each having a plurality of encryption keys,
said authenticating process is executed prior to said steps (b) to (c), and further includes the step of:
(a) transmitting and receiving data between said one side and said other side to recognize one key bundle of said predetermined number of key bundles as a key bundle for use in said steps (b) to (e).

7. The authentication method according to claim 1 wherein
said initial communication random-number data includes original random-number data itself, and
said initial random-number recognition method includes a method for recognizing said initial communication random-number data as said original random-number data.

8. The authentication method according to claim 1, wherein
the storage part of each of said first and second authentication devices has a common initial encryption key,
said initial communication random-number data includes data obtained by encrypting original random-number data using said initial encryption key, and
said initial random-number recognition method includes a method for decrypting said initial communication random-number data using said initial encryption key so as to obtain said original random-number data.

9. The authentication method according to claim 1 wherein
the authenticating process further includes the step of:
(f) after execution of said step (e), replacing said one side replaced with said other side, and vice versa, executing the processes of said steps (b) to (e) again so as to determine whether or not an authentication result is acceptable.

10. The authentication method according to claim 2 wherein
said initial communication random-number data includes original random-number data itself, and
said initial random-number recognition method includes a method for recognizing said initial communication random-number data as said original random-number data.

11. The authentication method according to claim 2, wherein
the storage part of each of said first and second authentication devices has a common initial encryption key,
said initial communication random-number data includes data obtained by encrypting original random-number data using said initial encryption key, and
said initial random-number recognition method includes a method for decrypting said initial communication random-number data using said initial encryption key so as to obtain said original random-number data.

12. The authentication method according to claim 2 wherein
the authenticating process further includes the step of:
(f) after execution of said step (e), replacing said one side replaced with said other side, and vice versa, executing the processes of said steps (b) to (e) again so as to determine whether or not an authentication result is acceptable.

13. The authentication method according to claim 4, wherein
said key bundle includes a predetermined number of key bundles each having a plurality of encryption keys,
said authenticating process is executed prior to said steps (b) to (c), and further includes the step of:
(a) transmitting and receiving data between said one side and said other side to recognize one key bundle of said predetermined number of key bundles as a key bundle for use in said steps (b) to (e).

14. The authentication method according to claim 4 wherein
said initial communication random-number data includes original random-number data itself, and
said initial random-number recognition method includes a method for recognizing said initial communication random-number data as said original random-number data.

15. The authentication method according to claim 4, wherein
the storage part of each of said first and second authentication devices has a common initial encryption key,
said initial communication random-number data includes data obtained by encrypting original random-number data using said initial encryption key, and
said initial random-number recognition method includes a method for decrypting said initial communication random-number data using said initial encryption key so as to obtain said original random-number data.

16. The authentication method according to claim 4, wherein
the authenticating process further includes the step of:
(f) after execution of said step (e), replacing said one side replaced with said other side, and vice versa, executing the processes of said steps (b) to (e) again so as to determine whether or not an authentication result is acceptable.

17. An authentication system which has first and second constituent elements and executes mutual authentication upon an operation object capable of executing a predetermined operation by cooperation between said first and second constituent elements by using a predetermined authentication method between said first and second constituent elements, wherein
said predetermined authentication method includes an authentication method for authenticating commonality of encryption keys possessed by first and second authentication devices,
each of said first and second authentication devices includes:
an authentication processing part for executing an authenticating process; and
a transmission/reception part for transmitting and receiving data at the time of said authenticating process,
said authentication processing part includes:
an authenticating process control part for executing and controlling said authenticating process;
a storage part for storing a key bundle having a plurality of encryption keys, each of said key bundles containing a predetermined number of key bundles each having a plurality of encryption keys;
an encryption/decryption circuit for encrypting and decrypting data using a selection encryption key; and
a random-number generation circuit for generating random-number data,
said authenticating process is executed in such a state that data transmission and reception via each transmission/reception part is enabled with the first authentication device as one side and the second authentication device as the other side, and includes the steps of:
(a) recognizing a selection key bundle which is one key bundle contained in said predetermined number of key bundles by data transmission and reception between said one side and said other side;
(b) transmitting initial communication random-number data based on original random-number data which is random-number data generated from said authentication processing part from said one side to said other side, said one side executing a predetermined association based on said original random-number data to select one encryption key from said plurality of encryption keys in said selection key bundle as a selection encryption key for the one side;
(c) receiving the initial communication random-number data on said other side, acquiring the original random-number data from said initial communication random-number data using an initial random-number recognition method, executing said predetermined association based on the original random-number data to select one encryption key from said plurality of encryption keys in said selection key bundle as a selection encryption key for the other side, acquiring encrypted random-number data by encrypting said original random-number data using the selection encryption key for the other side, and transmitting the encrypted random-number data to said one side;
(d) receiving said encrypted random-number data on said one side, and acquiring decrypted random-number data by decrypting said encrypted random-number data using said selection encryption key for the one side; and
(e) comparing said original random-number data with said decrypted random-number data on said one side and determining whether or not an authentication result is acceptable depending on whether the comparison result is consistent or inconsistent,
said first constituent element has said first authentication device,
said second constituent element has said second authentication device, and
said authenticating process is executed according to said authentication method between said first and second authentication devices, and after it is determined that its authentication result is acceptable, said predetermined operation of said operation object is made possible.

18. The authentication system according to claim 17, wherein
said operation object includes an electric bicycle,
said first constituent element includes an electric bicycle key,
said second constituent element includes a battery,
said authenticating process by said authentication method is executed when said electric bicycle key is inserted into said electric bicycle, and the function of said electric bicycle is limited when it is determined that the authentication result is unacceptable, and
said predetermined operation of said operation object includes driving of said electric bicycle accompanied by supply of power from said battery.

19. An authentication system which, with a second constituent element and a plurality of first constituent elements possessed by an operation object, executes mutual authentication upon the operation object capable of executing a predetermined operation by cooperation between one of said first constituent elements and said second constituent element using a predetermined authentication method between one of said first constituent element and said second constituent element, wherein
said predetermined authentication method includes an authentication method for authenticating commonality of encryption keys possessed by first and second authentication devices,
each of said first and second authentication devices includes:
an authentication processing part for executing an authenticating process; and
a transmission/reception part for transmitting and receiving data at the time of said authenticating process,
said authentication processing part includes:
an authenticating process control part for executing and controlling said authenticating process;
a storage part for storing a key bundle having a plurality of encryption keys, each of said key bundles containing a predetermined number of key bundles each having a plurality of encryption keys;
an encryption/decryption circuit for encrypting and decrypting data using a selection encryption key; and
a random-number generation circuit for generating random-number data,
said authenticating process is executed in such a state that data transmission and reception via each transmission/reception part is enabled with the first authentication device as one side and the second authentication device as the other side, and includes the steps of:
(a) recognizing a selection key bundle which is one key bundle contained in said predetermined number of key bundles by data transmission and reception between said one side and said other side;
(b) transmitting initial communication random-number data based on original random-number data which is random-number data generated from said authentication processing part from said one side to said other side, said one side executing a predetermined association based on said original random-number data to select one encryption key from said plurality of encryption keys in said selection key bundle as a selection encryption key for the one side;
(c) receiving the initial communication random-number data on said other side, acquiring the original random-number data from said initial communication random-number data using an initial random-number recognition method, executing said predetermined association based on the original random-number data to select one encryption key from said plurality of encryption keys in said selection key bundle as a selection encryption key for the other side, acquiring encrypted random-number data by encrypting said original random-number data using the selection encryption key for the other side, and transmitting the encrypted random-number data to said one side;
(d) receiving said encrypted random-number data on said one side, and acquiring decrypted random-number data by decrypting said encrypted random-number data using said selection encryption key for the one side; and
(e) comparing said original random-number data with said decrypted random-number data on said one side and determining whether or not an authentication result is acceptable depending on whether the comparison result is consistent or inconsistent,
each of said plurality of first constituent elements has said first authentication device,
said second constituent element has said second authentication device,
said second authentication device has all of said key bundles possessed by said plurality of first authentication devices, and
said authenticating process is executed according to said authentication method between one of said first constituent element and said second constituent element, and after it is determined that its authentication result is acceptable, said predetermined operation of said operation object is made possible.

20. The authentication system according to claim 19 wherein
said operation object includes a communication karaoke system using a communication line,
said plurality of first constituent elements include a plurality of terminals requesting data distribution for karaoke,
said second constituent element includes a server for distributing data for karaoke,
when said terminal is connected electrically to said communication line, said authenticating process according to said authentication method is executed and the function of said communication karaoke system is limited when it is determined that its authentication result is unacceptable, and
said predetermined operation of said operation object includes distribution operation of data for karaoke from said server to said terminal.

21. The authentication system according to claim 19, wherein
said operation object includes a plurality of shops each having a door,
said plurality of first constituent elements include door key holes provided at said plurality of doors of said plurality of shops,
said second constituent element includes said plurality of door keys,
said authenticating process according to said authentication method is executed when said door key is inserted into said door key hole, and
said predetermined operation of said operation object includes opening/closing of the door of said shop.

22. An authentication system which has first and second constituent elements and executes mutual authentication upon an operation object capable of executing a predetermined operation by cooperation between said first and second constituent elements by using a predetermined authentication method between said first and second constituent elements, wherein
said predetermined authentication method includes an authentication method for authenticating commonality of encryption keys possessed by first and second authentication devices,
each of said first and second authentication devices includes:
an authentication processing part for executing an authenticating process;
a transmission/reception part for transmitting and receiving data at the time of said authenticating process; and
a clock function,
said authentication processing part includes:
an authenticating process control part for executing and controlling said authenticating process;
a storage part for storing a key bundle having a plurality of encryption keys;
an encryption/decryption circuit for encrypting and decrypting data using a selection encryption key; and
a random-number generation circuit for generating random-number data,
said authenticating process is executed in such a state that data transmission and reception via each transmission/reception part is enabled with the first authentication device as one side and the second authentication device as the other side, and includes the steps of:
(b) transmitting initial communication random-number data based on original random-number data which is random-number data generated from said authentication processing part from said one side to said other side, said one side executing a predetermined association based on an authentication time for the one side at a predetermined timing in said authenticating process to select one encryption key from said plurality of encryption keys in said key bundle as a selection encryption key for the one side;
(c) receiving said initial communication random-number data on said other side, acquiring said original random-number data from said initial communication random-number data using an initial random-number recognition method, executing said predetermined association based on an authentication time for the other side capable of being identified with said authentication time for the one side to select one encryption key from said plurality of encryption keys in said key bundle as a selection encryption key for the other side, acquiring encrypted random-number data by encrypting said original random-number data using the selection encryption key for the other side, and transmitting the encrypted random-number data to said one side;
(d) receiving said encrypted random-number data on said one side, and acquiring decrypted random-number data by decrypting said encrypted random-number data using said selection encryption key for the one side; and
(e) comparing said original random-number data with said decrypted random-number data on said one side and determining whether or not an authentication result is acceptable depending on whether the comparison result is consistent or inconsistent,
said first constituent element has said first authentication device,
said second constituent element has said second authentication device, and
said authenticating process is executed according to said authentication method between said first and second authentication devices, and after it is determined that its authentication result is acceptable, said predetermined operation of said operation object is made possible.

23. The authentication system according to claim 22, wherein
said operation object includes an electric bicycle,
said first constituent element includes an electric bicycle key,
said second constituent element includes a battery,
said authenticating process by said authentication method is executed when said electric bicycle key is inserted into said electric bicycle, and the function of said electric bicycle is limited when it is determined that the authentication result is unacceptable, and
said predetermined operation of said operation object includes driving of said electric bicycle accompanied by supply of power from said battery.

24. An authentication system which, with a second constituent element and a plurality of first constituent elements possessed by an operation object, executes mutual authentication upon the operation object capable of executing a predetermined operation by cooperation between one of said first constituent elements and said second constituent element using a predetermined authentication method between one of said first constituent element and said second constituent element, wherein
said predetermined authentication method includes an authentication method for authenticating commonality of encryption keys possessed by first and second authentication devices,
each of said first and second authentication devices includes:
an authentication processing part for executing an authenticating process;
a transmission/reception part for transmitting and receiving data at the time of said authenticating process; and
a clock function,
said authentication processing part includes:
an authenticating process control part for executing and controlling said authenticating process;
a storage part for storing a key bundle having a plurality of encryption keys;
an encryption/decryption circuit for encrypting and decrypting data using a selection encryption key; and
a random-number generation circuit for generating random-number data,
said authenticating process is executed in such a state that data transmission and reception via each transmission/reception part is enabled with the first authentication device as one side and the second authentication device as the other side, and includes the steps of:
(b) transmitting initial communication random-number data based on original random-number data which is random-number data generated from said authentication processing part from said one side to said other side, said one side executing a predetermined association based on an authentication time for the one side at a predetermined timing in said authenticating process to select one encryption key from said plurality of encryption keys in said key bundle as a selection encryption key for the one side;
(c) receiving said initial communication random-number data on said other side, acquiring said original random-number data from said initial communication random-number data using an initial random-number recognition method, executing said predetermined association based on an authentication time for the other side capable of being identified with said authentication time for the one side to select one encryption key from said plurality of encryption keys in said key bundle as a selection encryption key for the other side, acquiring encrypted random-number data by encrypting said original random-number data using the selection encryption key for the other side, and transmitting the encrypted random-number data to said one side;
(d) receiving said encrypted random-number data on said one side, and acquiring decrypted random-number data by decrypting said encrypted random-number data using said selection encryption key for the one side; and
(e) comparing said original random-number data with said decrypted random-number data on said one side and determining whether or not an authentication result is acceptable depending on whether the comparison result is consistent or inconsistent,
each of said plurality of first constituent elements has said first authentication device,
said second constituent element has said second authentication device,
said second authentication device has all of said key bundles possessed by said plurality of first authentication devices, and
said authenticating process is executed according to said authentication method between one of said first constituent element and said second constituent element, and after it is determined that its authentication result is acceptable, said predetermined operation of said operation object is made possible.

25. The authentication system according to claim 24, wherein
said operation object includes a communication karaoke system using a communication line,
said plurality of first constituent elements include a plurality of terminals requesting data distribution for karaoke,
said second constituent element includes a server for distributing data for karaoke,
when said terminal is connected electrically to said communication line, said authenticating process according to said authentication method is executed and the function of said communication karaoke system is limited when it is determined that its authentication result is unacceptable, and
said predetermined operation of said operation object includes distribution operation of data for karaoke from said server to said terminal.

26. The authentication system according to claim 24, wherein
said operation object includes a plurality of shops each having a door,
said plurality of first constituent elements include door key holes provided at said plurality of doors of said plurality of shops,
said second constituent element includes said plurality of door keys,
said authenticating process according to said authentication method is executed when said door key is inserted into said door key hole, and
said predetermined operation of said operation object includes opening/closing of the door of said shop.

27. An authentication system which has first and second constituent elements and executes mutual authentication upon an operation object capable of executing a predetermined operation by cooperation between said first and second constituent elements by using a predetermined authentication method between said first and second constituent elements, wherein
said predetermined authentication method includes an authentication method for authenticating commonality of encryption keys possessed by first and second authentication devices,
each of said first and second authentication devices includes:
an authentication processing part for executing an authenticating process;
a transmission/reception part for transmitting and receiving data at the time of said authenticating process; and
a temperature sensor capable of measuring a temperature of a device as a detection temperature,
said authentication processing part includes:
an authenticating process control part for executing and controlling said authenticating process;
a storage part for storing a key bundle having a plurality of encryption keys;
an encryption/decryption circuit for encrypting and decrypting data using a selection encryption key; and
a random-number generation circuit for generating random-number data,
said authenticating process is executed in such a state that data transmission and reception via each transmission/reception part is enabled with the first authentication device as one side and the second authentication device as the other side, and includes the steps of:
(b) transmitting initial communication random-number data based on original random-number data which is random-number data generated from said authentication processing part from said one side to said other side, said one side executing a predetermined association based on a detection temperature on the one side detected by said temperature sensor at a predetermined timing during said authenticating process to select one encryption key from said plurality of encryption keys in said selection key bundle as a selection encryption key for the one side;
(c) receiving said initial communication random-number data on said other side, acquiring said original random-number data from said initial communication random-number data using an initial random-number recognition method, executing said predetermined association based on a detection temperature on the other side capable of being identified with said detection temperature on the one side to select one encryption key from said plurality of encryption keys in said selection key bundle as a selection encryption key for the other side, acquiring encrypted random-number data by encrypting said original random-number data using the selection encryption key for the other side, and transmitting the encrypted random-number data to said one side;
(d) receiving said encrypted random-number data on said one side, and acquiring decrypted random-number data by decrypting said encrypted random-number data using said selection encryption key for the one side; and
(e) comparing said original random-number data with said decrypted random-number data on said one side and determining whether or not an authentication result is acceptable depending on whether the comparison result is consistent or inconsistent,
said first constituent element has said first authentication device,
said second constituent element has said second authentication device, and
said authenticating process is executed according to said authentication method between said first and second authentication devices, and after it is determined that its authentication result is acceptable, said predetermined operation of said operation object is made possible.

28. The authentication system according to claim 27, wherein
said operation object includes an electric bicycle,
said first constituent element includes an electric bicycle key,
said second constituent element includes a battery,
said authenticating process by said authentication method is executed when said electric bicycle key is inserted into said electric bicycle, and the function of said electric bicycle is limited when it is determined that the authentication result is unacceptable, and
said predetermined operation of said operation object includes driving of said electric bicycle accompanied by supply of power from said battery.

29. An authentication system which, with a second constituent element and a plurality of first constituent elements possessed by an operation object, executes mutual authentication upon the operation object capable of executing a predetermined operation by cooperation between one of said first constituent elements and said second constituent element using a predetermined authentication method between one of said first constituent element and said second constituent element, wherein
said predetermined authentication method includes an authentication method for authenticating commonality of encryption keys possessed by first and second authentication devices,
each of said first and second authentication devices includes:
an authentication processing part for executing an authenticating process;
a transmission/reception part for transmitting and receiving data at the time of said authenticating process; and
a temperature sensor capable of measuring a temperature of a device as a detection temperature,
said authentication processing part includes:
an authenticating process control part for executing and controlling said authenticating process;
a storage part for storing a key bundle having a plurality of encryption keys;
an encryption/decryption circuit for encrypting and decrypting data using a selection encryption key; and
a random-number generation circuit for generating random-number data,
said authenticating process is executed in such a state that data transmission and reception via each transmission/reception part is enabled with the first authentication device as one side and the second authentication device as the other side, and includes the steps of:
(b) transmitting initial communication random-number data based on original random-number data which is random-number data generated from said authentication processing part from said one side to said other side, said one side executing a predetermined association based on a detection temperature on the one side detected by said temperature sensor at a predetermined timing during said authenticating process to select one encryption key from said plurality of encryption keys in said selection key bundle as a selection encryption key for the one side;
(c) receiving said initial communication random-number data on said other side, acquiring said original random-number data from said initial communication random-number data using an initial random-number recognition method, executing said predetermined association based on a detection temperature on the other side capable of being identified with said detection temperature on the one side to select one encryption key from said plurality of encryption keys in said selection key bundle as a selection encryption key for the other side, acquiring encrypted random-number data by encrypting said original random-number data using the selection encryption key for the other side, and transmitting the encrypted random-number data to said one side;
(d) receiving said encrypted random-number data on said one side, and acquiring decrypted random-number data by decrypting said encrypted random-number data using said selection encryption key for the one side; and
(e) comparing said original random-number data with said decrypted random-number data on said one side and determining whether or not an authentication result is acceptable depending on whether the comparison result is consistent or inconsistent,
each of said plurality of first constituent elements has said first authentication device,
said second constituent element has said second authentication device,
said second authentication device has all of said key bundles possessed by said plurality of first authentication devices, and
said authenticating process is executed according to said authentication method between one of said first constituent element and said second constituent element, and after it is determined that its authentication result is acceptable, said predetermined operation of said operation object is made possible.

30. The authentication system according to claim 29, wherein
said operation object includes a communication karaoke system using a communication line,
said plurality of first constituent elements include a plurality of terminals requesting data distribution for karaoke,
said second constituent element includes a server for distributing data for karaoke,
when said terminal is connected electrically to said communication line, said authenticating process according to said authentication method is executed and the function of said communication karaoke system is limited when it is determined that its authentication result is unacceptable, and
said predetermined operation of said operation object includes distribution operation of data for karaoke from said server to said terminal.

31. The authentication system according to claim 29 wherein
said operation object includes a plurality of shops each having a door,
said plurality of first constituent elements include door key holes provided at said plurality of doors of said plurality of shops,
said second constituent element includes said plurality of door keys,
said authenticating process according to said authentication method is executed when said door key is inserted into said door key hole, and
said predetermined operation of said operation object includes opening/closing of the door of said shop.
